(19) United States
(12) Patent Application Publication
(10) Pub. No.: US 2007/0143218 A1
(43) Pub. Date: Jun. 21, 2007

(54) Method and apparatus for reporting usage of multimedia content by multimedia-enabled devices

(75) Inventor: Yojak H. Vasa, Morrisville, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/311,764

(22) Filed: Dec. 19, 2005

(51) Int. Cl. G06Q 99/00

(52) U.S. Cl. 705/51

(57) ABSTRACT

A multimedia-enabled device reports usage of multimedia content by the device to a remote system associated with the multimedia content. For example, the multimedia-enabled device maintains usage data at a multimedia-enabled device by tracking usage of multimedia content received from or associated with a content provider and reports the usage data to the content provider. In one or more embodiments, the multimedia-enabled device comprises a usage monitoring processor configured to maintain usage data at the multimedia-enabled device by tracking usage of multimedia content received from or associated with a content provider and report the usage data to the content provider. For example, the content provider may comprise an electronic system, such as a web server, that includes an information usage processor configured to associate usage metrics derived from collected usage data with the corresponding content. The availability of usage metrics, for example, can be used to guide prospective content users.

### BACKGROUND OF THE INVENTION

The present invention relates to multimedia services, and particularly relates to collecting and processing data corresponding to usage of multimedia content by multimedia-enabled devices.

The Internet has spawned various multimedia distribution technologies. Multimedia distribution technologies allow multimedia-enabled devices to access or otherwise process remotely stored multimedia content. In some applications, multimedia-enabled devices gain access to multimedia content via electronic feeds such as podcasts which provide aggregated links to a multiplicity of website content. In other applications, multimedia-enabled devices download or otherwise directly access multimedia content provided by remote systems.

Electronic content providers, i.e., systems that directly or indirectly provide electronic information such as multimedia content to remote devices, may monitor access activity by remote devices. That is, electronic content providers may monitor the propensity of users to access particular multimedia content provided by or associated with the content providers. For example, some conventional techniques track “popularity” for particular multimedia content by monitoring the number of times particular content is downloaded by users. In another example, content providers permit users to rate, e.g., on a scale of one to five stars, available content. Of course, in the first instance, download frequency does not relate to actual user satisfaction regarding the downloaded content and, in the second instance, the star rating relies on manual feedback from users.

### SUMMARY OF THE INVENTION

The methods and apparatus taught herein provide a multimedia-enabled device that reports usage of multimedia content to a remote system associated with the multimedia content. By way of non-limiting example, a multimedia-enabled device maintains usage data at the device by tracking usage of multimedia content received from or associated with a content provider and reports the usage data to the content provider. Thus, in one or more embodiments, the multimedia-enabled device comprises a usage monitoring processor configured to maintain usage data at the device by tracking usage of multimedia content received from or associated with a content provider, and to report the usage data to the content provider.

Corresponding to the above multimedia usage reporting methods and devices, a complementary electronic system comprises a usage information processor. The usage information processor is configured to obtain usage data indicating usage of multimedia content by a plurality of remote multimedia-enabled devices and process the usage data to generate one or more usage metrics for indicating collective usage of the multimedia content by the remote multimedia-enabled devices. The usage information processor is further configured to associate the one or more usage metrics with the multimedia content to indicate collective usage of the multimedia content.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of a multimedia-enabled device communicatively coupled to an electronic content provider.

FIG. 2 is a logic flow diagram of an embodiment of processing logic to generate usage metrics for indicating collective usage of multimedia content.

FIG. 3 is a logic flow diagram of an embodiment of processing logic to associate collective usage of remotely-accessed multimedia content with the multimedia content.

FIG. 4 is a block diagram of another embodiment of a multimedia-enabled device.

FIG. 5 is a logic flow diagram of an embodiment of processing logic to report multimedia usage data by a multimedia-enabled device.

### DETAILED DESCRIPTION OF THE INVENTION

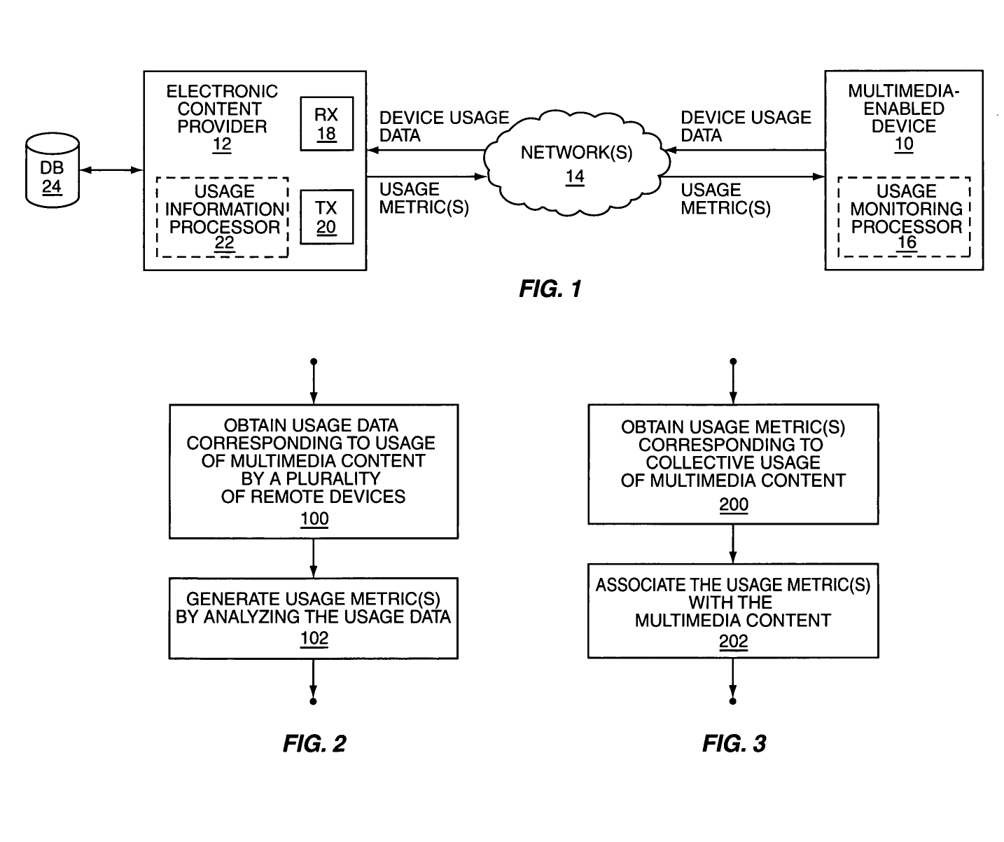

FIG. 1 illustrates an embodiment of a multimedia-enabled device 10 communicatively coupled to an electronic content provider 12, i.e., a system such as a web server or other network-centric system that directly or indirectly distributes multimedia content for access and/or retrieval by the device 10. The device 10 is coupled to the content provider 12 via a network 14 and accesses multimedia content provided by or associated with the content provider 12 via the network 14. The device 10 tracks or monitors usage of multimedia content each time the device 10 “plays” or otherwise uses the multimedia content. Particularly, the device 10 includes a usage monitoring processor 16 for tracking usage of multimedia content, as is discussed in detail later. The device 10 reports usage data to a remote system associated with the multimedia content, e.g., to the originating content provider 12 or a system associated with, or otherwise affiliated in some way with the content provider 12.

Generally, the content provider 12 also obtains usage data associated with the same multimedia content from other remote devices (not shown). That is, for particular multimedia content, such as a particular podcast, music video, etc., the content provider 12 obtains usage data from a plurality of users that downloaded or otherwise accessed that particular multimedia content. In some cases, the content provider 12 may be configured to obtain usage data from users that obtained or otherwise accessed content through the content provider, while, in other cases, the content provider 12 may collect usage data, or related usage metrics, for users that obtained the particular multimedia content from elsewhere.

In either case, the content provider 12 directly or indirectly generates one or more usage metrics by processing the usage data. The usage metrics provide a means for assessing or measuring the collective usage of particular multimedia content by remote devices that have used or are using the particular content. The usage metrics may reflect one or more of popularity, likeability, and user satisfaction. The content provider 12 associates usage metrics with corresponding multimedia content to indicate collective usage metrics for the content, which is useful to subsequent, prospective users of the content. That is, the content provider 12 may generate or otherwise obtain usage metrics reflecting the real-world enjoyment, popularity, or overall likeability of a particular multimedia file that is available for download or access, as based on actual reported usage by past and/or current users of the content. Such data thus provides prospective users with substantive information on which to select multimedia content.

In one or more embodiments, an auxiliary system (not shown) associated with the content provider 12 assists in processing usage data obtained from remote devices, such as the multimedia-enabled device 10, that are configured to track and report multimedia content usage. The auxiliary system, which may be operated locally or remotely by the content provider 12 or by a third-party system, processes usage data received directly by the auxiliary system or forwarded by the content provider 12. The auxiliary system processes the usage data to obtain usage metrics and forwards the usage metrics to the content provider 12 or provides the usage metrics to remote devices that subsequently access the multimedia content. In other words, the auxiliary system acts as a processing conduit for the content provider 12. As such, the content provider 12 can directly or indirectly receive usage data and process it accordingly or an auxiliary system can process the usage data. Unless otherwise noted, reference to the content provider 12 as discussed herein is to be construed to refer to either the content provider 12 or an auxiliary system associated with the content provider 12, or some combination thereof.

Returning to FIG. 1, multimedia content accessed by the device 10 is downloaded or otherwise accessed via the network 14. The network may comprise the Internet, one or more local or wide area networks, one or more wireless networks, or some combination thereof. In one example, the device 10 accesses multimedia content via electronic feeds such as podcasts. Electronic feeds provide aggregated links to a multiplicity of electronic content such as multimedia content. In other applications, the device 10 downloads or otherwise accesses multimedia content associated with the content provider 12 via the network 14.

The content provider 12 notifies the device 10 where to send usage data maintained by the device 10. In one example, the content provider 12 and the device 10 communicate using information embedded in metatags. In other examples, the content provider 12 and the device 10 communicate using one of various messaging techniques. Regardless, the device 10 is provided with information that indicates where the device 10 is to report usage data.

The content provider 12 includes receive and transmit elements 18, 20 for sending and receiving information, respectively, via the network. In one example, a usage information processor 22 receives usage data or usage metrics through the receive element 18, and transmits such information (or the metrics) through the transmit element 20. In operation, the content provider 12, as illustrated by Step 100 of FIG. 2, obtains usage data from remote devices such as the multimedia-enabled device 10. The usage information processor 22, as illustrated by Step 102 of the program logic of FIG. 2, generates one or more usage metrics corresponding to the collective usage data obtained by the content provider 12. The usage information processor 22 may comprise one or more general or special purpose microprocessors, digital signal processors, application specific integrated circuits, field programmable gate arrays, and/or other types of digital processing circuits, configured according to computer program instructions implemented in software (or firmware). Such circuits may be shared with other signal and control functions of the electronic content provider 12.

The usage information processor 22 generates usage metrics by statistically analyzing collective usage data. In one example, the usage information processor 22 averages collective usage data to provide a mean usage metric. In another example, the usage information processor 22 increments one or more counters associated with collective usage data to provide a cumulative usage metric. In other examples, the usage information processor 22 performs other statistical-based analyses to generate usage metrics relating to frequency of use, duration of use, mean time between use, etc. Regardless of the particular analysis technique, the usage information processor 22 generates one or more usage metrics for use by the content provider 12.

The content provider 12 associates usage metrics with corresponding multimedia content. Particularly, the content provider 12, as illustrated by Step 200 of FIG. 3, obtains one or more usage metrics from the usage information processor 22. The usage metrics may be obtained directly from the usage information processor 22 or indirectly via the network 14. The content provider 12, as illustrated by Step 202 of FIG. 3, associates the usage metrics with the corresponding multimedia content. As such, users who subsequently access the multimedia content may utilize the usage metrics to assist them in deciding what multimedia content to access. For example, prospective users contemplating multimedia content purchases through the content provider 12 may use the usage metrics to inform their purchase decisions.

In one example, the content provider 12 associates usage metrics with corresponding multimedia content by electronically linking the usage metrics with the multimedia content. For example, the content provider 12 links usage metrics with corresponding multimedia content in a webpage. As such, a user of a remote device, such as the multimedia-enabled device 10, views both the usage metrics and corresponding multimedia content when the device 10 accesses the webpage. In another example, the content provider 12 stores usage metrics and corresponding multimedia content in a database 24 for subsequent use. In yet another example, the content provider 12 embeds usage metrics in an electronic feed associated with particular multimedia content. In a non-limiting example, the content provider 12 embeds a usage metric in an electronic feed by representing the usage metric as metadata, e.g., by coding the usage metric in a channel element or sub-element of an RSS feed. As such, the usage metrics are associated with one or more of the aggregated links of the electronic feed. Thus, a user of the device 10 may utilize the usage metrics when deciding what links within the feed to access.

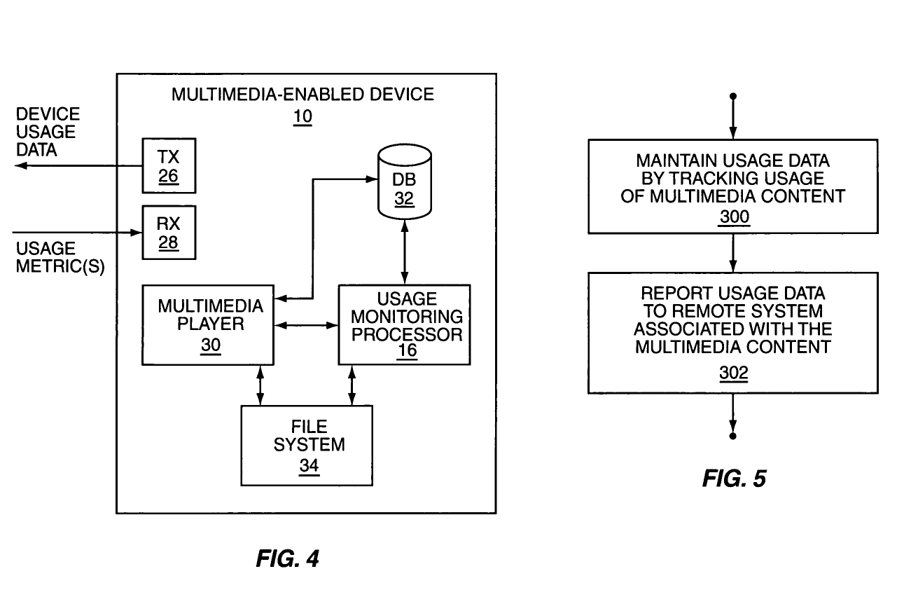

FIG. 4 illustrates an embodiment of the multimedia-enabled device 10. The device 10 includes the usage monitoring processor 16, a transmitter 26, a receiver 28, a multimedia player 30, a database 32, and a file system 34. The usage monitoring processor 16 may comprise one or more general or special purpose microprocessors, digital signal processors, application specific integrated circuits, field programmable gate arrays, and/or other types of digital processing circuits, configured according to computer program instructions implemented in software (or firmware). Such circuits may be shared with other signal and control functions of the multimedia-enabled device 10.

The device 10 has at least direct or indirect intermittent connectivity to the network 14. For example, the device 10 may comprise a computer, portable computer, portable communications device, cell phone, handheld device, PDA, etc. The transmitter and receiver 26, 28 send and receive, respectively, information via the network 14. In one example, the transmitter 26 sends usage data to a destination address as indicated by the content provider 12. The receiver 28 receives information including multimedia content from the content provider 12. For example, the receiver 28 receives electronic feeds and corresponding usage metrics. The multimedia player 30 comprises one or more digital processing circuits configured according to computer program instructions implemented in software (or firmware) for playing different forms of multimedia content available to the device 10.

After the multimedia player 30 begins playback of particular multimedia content or the device 10 initiates other use of the multimedia content, the usage monitoring processor 16, as illustrated by Step 300 of FIG. 5, maintains usage data corresponding to use of the content by the device 10. Particularly, the usage monitoring processor 16 tracks one or more parameters relating to usage of the multimedia content. For example, the usage monitoring processor 16 tracks parameters relating to temporal usage, frequency of use, duration of use and distribution of the multimedia content to other remote devices. The file system 34 of the device 10 may provide additional parameters to the usage monitoring processor 16 for improving multimedia usage tracking. For example, the file system 34 identifies certain actions taken by the device 10 relating to usage of multimedia content. The file system 34 identifies when a multimedia file is played, deleted, or distributed to other remote devices, and provides corresponding timestamps associated with the aforementioned actions.

Tracked multimedia usage data is stored in the database 32 for subsequent reporting to the content provider 12. In one example, the database 32 includes records corresponding to multimedia content usage. Other pertinent information may be stored in the database 32. For example, demographic information associated with one or more users of the device 10 may be stored. Further, location or geographic information such as zip codes, area codes, addresses, etc. associated with one or more users of the device 10 may be stored. In addition, a destination address for sending usage data associated with specific multimedia content may also be stored in the database 32. Alternatively, individual files may be maintained by the usage monitoring processor 16, where each file includes usage data and other pertinent data as described above.

Upon subsequent use of particular multimedia content, the usage monitoring processor 16 maintains the corresponding usage data by modifying those fields of the usage data affected by the subsequent use. When particular multimedia content becomes disassociated from the device 10, the corresponding usage data is removed from the device 10, e.g., by deleting a database record or file associated with the content. Multimedia content becomes disassociated from the device 10 when the content is deleted from or no longer used by or associated with the device 10. Likewise, multimedia content becomes disassociated from the device 10 when an electronic feed corresponding to the content is no longer received by the device 10.

The device 10, as illustrated by Step 302 of FIG. 5, reports usage data to the content provider 12 for analysis as previously described. The device 10 may report all usage data associated with particular multimedia content each time a report is sent. Alternatively, bandwidth limited devices may report only modified usage data. That is, bandwidth-limited devices report only those fields of the usage data that were modified after the most recent report was sent to the content provider.

The device 10 routinely reports usage data to the content provider 12. For example, the content provider 12 instructs the device 10 when to report usage data, e.g., at intervals identified by the content provider 12. In another example, the device 10 reports usage data after a predetermined number of uses of the multimedia content by the device 10. The content provider 12 uses the routine reports to modify usage metrics. As such, changes in usage of particular multimedia content are reflected in the usage metrics associated with the content.

Thus, while the invention has been described in terms of specific embodiments, it should be understood that the present invention is not limited by the foregoing description, nor is it limited by the accompanying drawings. Instead, the present invention is limited only by the following claims and their legal equivalents.

What is claimed is:

1. A method of reporting multimedia usage data by a multimedia-enabled device, comprising:
maintaining usage data at the multimedia-enabled device by tracking usage of multimedia content received from or associated with a content provider; and
reporting the usage data to the content provider.

2. The method of claim 1, further comprising reporting at least one of demographic information associated with a user of the multimedia-enabled device and location information associated with the user in conjunction with reporting the usage data.

3. The method of claim 1, wherein maintaining the usage data at the multimedia-enabled device by tracking usage of multimedia content received from or associated with the content provider comprises modifying previously tracked usage data responsive to a subsequent use of the multimedia content by the multimedia-enabled device.

4. The method of claim 3, wherein reporting the usage data to the content provider comprises reporting the modified usage data to the content provider.

5. The method of claim 1, wherein maintaining the usage data at the multimedia-enabled device by tracking usage of the multimedia content received from or associated with the content provider comprises tracking one or more of temporal usage of the multimedia content, frequency of use of the multimedia content, duration of use of the multimedia content, and distribution of the multimedia content.

6. The method of claim 1, further comprising deleting usage data corresponding to multimedia content disassociated from the multimedia-enabled device.

7. The method of claim 1, wherein reporting the usage data to the content provider comprises reporting the usage data to the content provider at intervals identified by the content provider.

8. The method of claim 1, wherein reporting the usage data to the content provider comprises reporting the usage data to the content provider after a predetermined number of uses of the multimedia content by the multimedia-enabled device.

9. The method of claim 1, wherein reporting the usage data to the content provider comprises reporting the usage data to a destination address identified by the content provider.

10. A multimedia-enabled device, comprising a usage monitoring processor configured to maintain usage data at the multimedia-enabled device by tracking usage of multimedia content received from or associated with a content provider and report the usage data to the content provider.

11. The multimedia-enabled device of claim 10, wherein the usage monitoring processor is further configured to report at least one of demographic information associated with a user of the multimedia-enabled device and location information associated with the device user in conjunction with reporting the usage data.

12. The multimedia-enabled device of claim 10, wherein the usage monitoring processor is configured to maintain the usage data by modifying previously tracked usage data responsive to a subsequent use of the multimedia content by the multimedia-enabled device.

13. The multimedia-enabled device of claim 12, wherein the usage monitoring processor is configured to report the usage data to the content provider by reporting the modified usage data to the content provider.

14. The multimedia-enabled device of claim 10, wherein the usage monitoring processor is configured to maintain the usage data at the multimedia-enabled device by tracking one or more of temporal usage of the multimedia content, frequency of use of the multimedia content, duration of use of the multimedia content, and distribution of the multimedia content.

15. The multimedia-enabled device of claim 10, wherein the usage monitoring processor is further configured to delete usage data corresponding to multimedia content disassociated from the multimedia-enabled device.

16. The multimedia-enabled device of claim 10, wherein the usage monitoring processor is configured to report the usage data to the content provider by reporting the usage data to the content provider at intervals identified by the content provider.

17. The multimedia-enabled device of claim 10, wherein the usage monitoring processor is configured to report the usage data to the content provider by reporting the usage data to the content provider after a predetermined number of uses of the multimedia content by the multimedia-enabled device.

18. The multimedia-enabled device of claim 10, wherein the usage monitoring processor is configured to report the usage data to the content provider by reporting the usage data to a destination address identified by the content provider.

19. A method of providing usage information for multimedia content that is remotely accessible by multimedia-enabled devices, comprising:
obtaining usage data indicating usage of multimedia content by a plurality of multimedia-enabled remote devices;
processing the usage data to generate one or more usage metrics for indicating collective usage of the multimedia content by the remote multimedia-enabled devices; and
associating the one or more usage metrics with the multimedia content to indicate collective usage of the multimedia content.

20. The method of claim 19, wherein obtaining the usage data comprises obtaining tracked usage information from individual ones of the remote multimedia-enabled devices.

21. The method of claim 19, wherein associating the one or more usage metrics with the multimedia content comprises electronically linking the one or more usage metrics with the multimedia content.

22. The method of claim 19, wherein associating the one or more usage metrics with the multimedia content comprises linking the one or more usage metrics with the multimedia content in a webpage.

23. The method of claim 19, wherein associating the one or more usage metrics with the multimedia content comprises including the one or more usage metrics in an electronic feed associated with the multimedia content.

24. The method of claim 19, wherein associating the one or more usage metrics with the multimedia content comprises creating a database record comprising the one or more usage metrics and an identifier corresponding to the multimedia content.

25. The method of claim 19, wherein processing the usage data to generate one or more usage metrics comprises calculating at least one of a mean usage metric, a cumulative usage metric, a frequency usage metric, a duration usage metric, and a temporal usage metric.

26. The method of claim 19, wherein obtaining the usage data comprises obtaining tracked usage information from individual ones of the remote multimedia-enabled devices at intervals identified by a content server associated with the multimedia content.

27. The method of claim 19, wherein obtaining the usage data comprises obtaining tracked usage information from individual ones of the remote multimedia-enabled devices after a predetermined number of uses of the multimedia content by the individual ones of the remote multimedia-enabled devices.

28. An electronic system, comprising a usage information processor configured to obtain usage data indicating usage of multimedia content by a plurality of remote multimedia-enabled devices, process the usage data to generate one or more usage metrics for indicating collective usage of the multimedia content by the remote multimedia-enabled devices, and associate the one or more usage metrics with the multimedia content to indicate collective usage of the multimedia content.

29. The electronic system of claim 28, wherein the usage information processor is configured to obtain the usage data by obtaining tracked usage information from individual ones of the remote multimedia-enabled devices.

30. The electronic system of claim 28, wherein the usage information processor is configured to associate the one or more usage metrics with the multimedia content by electronically linking the one or more usage metrics with the multimedia content.

31. The electronic system of claim 28, wherein the usage information processor is configured to associate the one or more usage metrics with the multimedia content by linking the one or more usage metrics with the multimedia content in a webpage.

32. The electronic system of claim 28, wherein the usage information processor is configured to associate the one or more usage metrics with the multimedia content by including the one or more usage metrics in an electronic feed associated with the multimedia content.

33. The electronic system of claim 28, wherein the usage information processor is configured to associate the one or more usage metrics with the multimedia content by creating a database record comprising the one or more usage metrics and an identifier corresponding to the multimedia content.

34. The electronic system of claim 28, wherein the usage information processor is configured to process the usage data to generate one or more usage metrics by calculating at least one of a mean usage metric, a cumulative usage metric, a frequency usage metric, a duration usage metric, and a temporal usage metric.

35. The electronic system of claim 28, wherein the electronic system comprises a web server configured to provide access to the multimedia content to individual ones of the remote multimedia-enabled devices, obtain the usage data from individual ones of the remote multimedia-enabled devices, and link the one or more usage metrics with the multimedia content to indicate collective usage of the multimedia content to prospective users of the multimedia content.

36. The electronic system of claim 35, wherein the web server is configured to obtain the usage data by obtaining tracked usage information from individual ones of the remote multimedia-enabled devices at intervals identified by the web server.

37. The electronic system of claim 35, wherein the web server is configured to obtain the usage data by obtaining tracked usage information from individual ones of the remote multimedia-enabled devices after a predetermined number of uses of the multimedia content by the individual ones of the remote multimedia-enabled devices.
